(19) United States
(12) Patent Application Publication
(10) Pub. No.: US 2002/0112243 A1
(43) Pub. Date: Aug. 15, 2002

(54) Video distribution system

(75) Inventors: Charles E. Hunter, Hilton Head, SC (US); Bernard L Ballou JR., Raleigh, NC (US); Kelly C. Sparks, Morrisville, NC (US); John H. Hebrank, Durham, NC (US)

Correspondence Address: Finnegan Henderson Farabow Garrett & Dunner LLP, 1300 I Street N W, Washington, DC, 20005-3315, US

(73) Assignee: World Theatre

(21) Appl. No.: 09/781,679

(22) Filed: Feb. 12, 2001

(51) Int. Cl. H04N 7/16; H04H 9/00; H04N 7/173

(52) U.S. Cl. 725/92; 725/115; 725/9; 725/1

(57) ABSTRACT

Movies are distributed to customer households in a secure format on digital media such as optical disks for playback via proprietary set-top boxes. A system operator produces movie disks in large quantities and delivers the disks to widely geographically dispersed distribution agents. Agents produce copies of the disks with unique agent identification codes embedded therein, and distribute the disks to local customers who have compatible playback devices. When customers view movies, information identifying the movie and a distribution agent who is responsible for the movie being distributed to that customer are communicated to the central computer of the system operator. The content providers are then paid royalties due and responsible distribution agents are compensated.

### FIELD OF THE INVENTION

The invention relates to video distribution systems and, more particularly, to a system wherein movies and, optionally, other video content are distributed to consumers in a secure format on digital media such as optical disks for playback via proprietary set-top boxes.

### DESCRIPTION OF THE PRIOR ART

Widespread home television viewing began in approximately 1950 with broadcast networks transmitting shows on specific, prepublished schedules. This model remained the primary model for television viewing for over thirty years.

Cable, and later direct broadcast satellite, increased the number of channels. But viewers were still subject to programming schedules.

Video cassette recorders offered the prospect of shifting viewing times, provided the end user was one of the thirty percent or less of VCR owners who learned to program their VCR's. Even among those who learned to program their VCR, time shifting via VCR remains subject to properly setting up the timer, assuring the power is in the correct state, assuring that a correct tape is in the VCR, that the tape is not full, that the tape is properly rewound, etc. Thus, for the majority of TV viewers, even at the turn of the century, the TV viewing model has scarcely changed from the mode of 1950.

Video rental stores have provided a sort of “video on demand”, subject, of course, to the high cost of video cassette purchases by the rental stores, as well as the high capital outlay for real estate (land and building) and the cost of labor at the stores. Even when a title becomes available through video release, the viewer's ability to watch the show at his chosen time is subject to availability of the video at the store, round-trip transportation to the store and the inevitable problems with late returns, damaged videos, lost videos, etc.

True video-on-demand has been envisioned whereby massive video servers would be positioned in every geographic location to transfer high speed video data streams to the houses of individual viewers at any time a viewer wished to access a particular movie or other content. However, this type of video on demand system, after years and billions of dollars of investment, has proven to be too complex and expensive and, therefore, has not been implemented.

Another type of on-demand video distribution system is described in U.S. Pat. No. 5,832,287, whereby video-on-demand and network programming is provided from master file and network program databases through multiple community systems, each of which may serve up to approximately one hundred homes.

An interactive viewing system that automatically records selected programs is disclosed in U.S. Pat. No. 5,805,763. However, the '763 system simply provides another mechanism for recording television programs. This system attempts to simplify the VCR recording function, but because of its complex nature and limited benefits it has not been implemented.

U.S. Pat. Nos. 5,619,247 and 6,025,868 disclose a stored program pay-per-play system wherein movies are stored on storage media for later playback, with the subscriber paying only when a particular movie is viewed.

For movie distribution companies to maximize the profits from a movie, it is necessary that a large number of viewers pay to see the movie, that a reasonable price is charged, and that ancillary costs such as advertising and theater commissions be minimized. The strategy of selling movies as VCR's or DVD's in entertainment stores such as WalMart, Circuit City and Blockbuster produces a relatively low volume of sales because of the high prices associated with the outright purchase of the movies. Similarly, movie rentals realize revenues each time a movie is rented, although profits must be shared, advertising still must be done, and piracy of movies through copying rented tapes reduces revenues. Similar drawbacks exist for cable and satellite pay-per-view movie channels.

Thus, there is an acute need in the video distribution industry for a system that will provide each individual viewer with ready access to thousands of movies titles (as well as, optionally, educational programming, classic network programming, audio programming, classic sporting events, and the like) in a convenient low-cost manner that fully satisfies user demand, while enhancing the economic incentives of content providers to create and distribute an ever expanding offering of movies and other video/audio content.

### SUMMARY OF THE INVENTION

The present invention provides a video distribution system that is beneficial to both consumers and movie distribution companies (“content providers”). Consumers are free to collect and archive movies at low cost or even no cost, and later make a decision as to which movies to actually view—paying a viewing fee for those movies that are actually viewed. Consumers may view the videos at any time without restraints related to broadcasting schedules and with no need to return the videos to a rental store (although return credits may be offered). There are no late fees. New movie releases may be made available in sufficient quantities so that they are unlikely to be “sold out”, as they frequently are in existing video rental stores. Another advantage to consumers is the ultimate lower cost occasioned by the system's reduction of the real estate and labor costs associated with existing video rental stores. Because literally thousands of movies may be made available, the video distribution system of the invention may provide a greater selection than existing video rental stores. The invention may also provide improved access to content for those who live in geographically remote and/or sparsely populated areas that may presently have little or no access to video rental stores. In certain embodiments, the present invention also provides the ability to update movie pricing at any time, for example on a daily, weekly or monthly basis, so that consumers can choose to view movies at times when content providers offer pricing specials or incentives.

Content providers recognize a very significant benefit in that they receive income every time a movie is played, thereby creating significant residual value for their investments. Importantly, new release movies may be made available in large numbers during initial peak demand when pricing power is the highest. The mentioned residual value translates into increased income for the content providers because a significant portion of existing content is available for viewing every day. The invention may be carried out in such a way as to allow content providers to change pricing at any time, e.g., daily/weekly/monthly, to optimize price vs. consumer demand. This provides an extremely high benefit by effectively allowing the market to clear (i.e., real demand matches supply), something that the current video distribution model (TV, movie channels, cable/satellite pay-per-view, DVD clubs and video rental) do not provide.

More particularly, the present invention employs a strategy for maximizing revenues to content providers by creating a large number of viewers who pay a fee each time they view a movie, and relies on an extension of word-of-mouth advertising, customer archiving of movies and other means to maximize the number of viewings.

This system distributes movies in the form of digital movie disks that can only be played on a low-cost set-top box that monitors and invoices/debits viewers each time a movie is played on a box. In certain preferred embodiments, movies are stored in compressed form on digital media such as low-cost, proprietary 2 gigabyte optical disks with multiple layers of protection to prevent piracy. The proprietary optical disk recording and playback technology may take the form of multilevel (ML) CD recording and playback technology developed and commercialized by the ML Alliance, or other suitable technology. Disks with movies are distributed to viewers in a manner that minimizes wasted media while maximizing number of plays through targeted distribution of the disks.

Targeted distribution of the disks may take place, at least in part, through widely geographically dispersed “distribution agents” who copy disks on machines capable of reading and making copies of the disks. In the case of the ML disks and other similar technologies, disk copying by agents is possible for a low cost because the proprietary optical disk technology permits the disks to be read and written by the same mass-market mechanical hardware used to read and write CD-R and RW disks. The ability to read and write to the mentioned ML disks is accomplished by addition of a single, proprietary chip to an otherwise normal CD device. Current ML writers can replicate a 2 hour movie disk in about six minutes. With the addition of a small disk-feed mechanism, a distribution agent can create 100 copies in a ten-hour period.

Reader/writers are distributed to agents who then make copies of the digital media (e.g., ML movie disks) and give away or sell these disks at modest cost to people likely to watch the movies. Distribution agents may include college students who make copies and give them to friends, movie clubs that send disks for a small fee to club members, traditional movie rental stores that sell or give away the disks or any appropriate retail outlet such as consumer electronics stores and properly equipped convenience marts.

In certain preferred embodiments, each disk contains an identification code for the agent that created and distributed the disk. Each time the disk is viewed, the agent can be paid for the viewing. At the same time agents may be charged a nominal amount for the raw optical disk media. Thus, it is in the agent's interest to maximize the number of viewings of each disk.

Players for the movies may include a CD reader with a proprietary chip that allows reading, a decoding/decompression/watermarking chip, an accounting computer and some form of communication to the video distribution system operator to allow compensation to the content providers and to the agent who created the copy that was viewed.

Piracy is discouraged by several features of this system. In the first instance, it will be appreciated that raw copying of disks can only enhance revenues since these disks can be played only on authorized boxes equipped with the proprietary chip. These boxes can be designed not to work if proper credit or connections is not established by the box with the video distribution system operator. Unauthorized recording of a movie with a recording device (e.g. VCR) connected to a box output is discouraged by watermarking that encodes the identification of the playback box in the video and/or audio signals that are sent to the viewer's TV. Extraction of the digital form of the movie is minimized by several layers of protection, including creating a proprietary reader for the movies, decrypting the movie, and decompressing it with the proper algorithm.

Decryption can be further hindered by requiring a decryption key specific to a reader that must be obtained from the central system each time a movie is viewed. Furthermore, the decryption key may be date dependent to further limit the development of a hacking scheme that would allow any user to obtain decryption software (as has been the situation with DVD movies). Should a single individual obtain a digital copy of the movie and distribute it, internal identification tags allow the source of the movie to be identified.

Many viewers desire the ability to archive movies, perhaps to create a large personal library that may be used by themselves, by friends or children or, for example, by renters at a beach cottage. The distribution of movies on low-cost, long-lived media encourages this. The cost of the physical material that makes up the digital media may be on the order of about $1 or less, similar to the raw cost of bulk VCR cassettes, however, the cost of placing a movie on such a disk is much lower since CD write mechanisms are cheaper than cassette write mechanisms, and the duplication time is faster by a factor of twenty or better.

In one aspect, the invention is carried out under authority of content providers who control the distribution rights to movies. Under this authority, digital movie disks are delivered to widely geographically dispersed distribution agents. Distribution agents produce copies of the movie disks, with each copy including an identification code that identifies the distribution agent who made the copy. The movie disk copies are distributed by the distribution agents to customer households that have playback devices compatible with the disks. Customer households are permitted to view desired movies through their playback devices. The customer households communicate movie playback information that identifies each movie that has been viewed and a distribution agent who is responsible for the movie being distributed to the customer household. As dictated by the movie playback information, the content providers and responsible distribution agents are compensated.

### BRIEF DESCRIPTION OF THE DRAWINGS

Some of the features of the invention having been stated, other features will appear as the description proceeds, when taken in connection with the accompanying drawings, in which

FIG. 1 shows the video distribution system components in a customer household connected to the central controller of the video distribution system operator.

FIG. 2 is a schematic representation of primary components of the play-only set-top box shown in FIG. 1.

FIG. 3 is a block diagram of one simplified embodiment of a business model for commercializing a video distribution system consistent with the invention.

### DETAILED DESCRIPTION OF THE INVENTION

While the present invention will be described more fully hereinafter with reference to the accompanying drawings, in which aspects of the preferred manner of practicing the present invention are shown, it is to be understood at the outset of the description which follows that persons of skill in the appropriate arts may modify the invention herein described while still achieving the favorable results of this invention. Accordingly, the description which follows is to be understood as being a broad, teaching disclosure directed to persons of skill in the appropriate arts, and not as limiting upon the present invention.

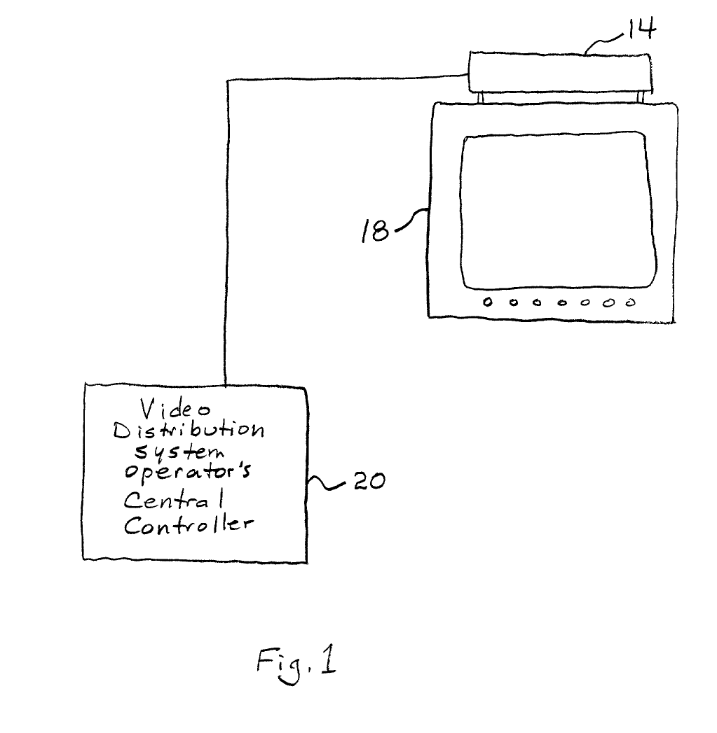

FIG. 1 is a diagram of the video distribution system components in a customer household. These components include a play-only set-top box 14 for playing proprietary disks that are distributed in accordance with the invention. Set-top box 14 is connected to a video display device such as television 18. Box 14 is also connected to the central controller 20 of the distribution system operator.

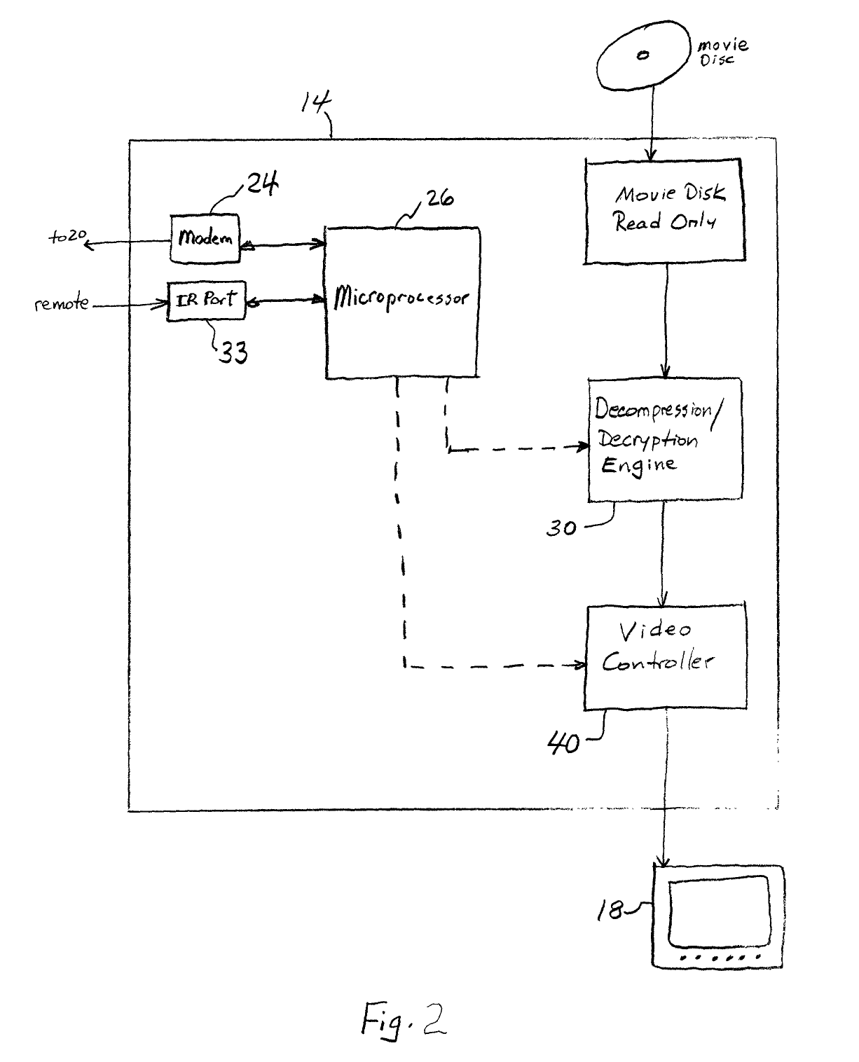

Box 14 has the capability to communicate with central controller 20 to conduct billing transactions resulting from movie playback on the box (or simple extension of “credit” to the box) and to communicate agent ID information. This communication may be accomplished through modem 24 (FIG. 2) that is connected to a standard POTS phone line, a DSL or ethernet port connected to a digital network or an internal cell phone. In the future, the communication may be possible by transmissions from box 14 to central controller system 20 via satellite. Similarly, where appropriate, box 14 may use the communication capabilities of the customer's satellite or cable box to achieve connection with the central computer system.

Microprocessor 26 within box 14 conducts the data transfer and communication functions of the box. This includes directing or handling the content bit-streams in or out of decompression engine 30, as well as communications with IR remotes (via IR part 33) and modem 24.

A video controller 40 functions to take the digital output from decompression engine 30 and convert the output into a conventional video signal.

Distribution agents who make authorized copies of the movie disks will have a proprietary (e.g. ML) disk duplication box (not shown). The box may take the form of a dual well box (two CD drives) having the capability to copy proprietary optical disks for distribution in the manner described elsewhere herein. In the alternative, distribution agents, particularly some of those who are home-based, may use a personal computer having an appropriate proprietary disk burner to reproduce proprietary CD-type optical disks as discussed below.

One preferred proprietary optical disk read/write system for use in accordance with the present invention is a system employing multilevel (ML) CD recording and playback technology developed and commercialized by the ML Alliance, comprising Calimetrics, Inc. of Alameda, Calif., USA; TDK; Mitsubishi Chemical; and Plextor. The ML technology is described in U.S. Pat. Nos. 5,235,587; 5,818,806; 5,854,779; 6,115,348; 6,148,428; and 6,150,964 and the attached Appendix A, IDC White Paper entitled “Calimetrics' Multilevel Technology Enables Higher-Performance CD/DVD Recorders”, IDC, Framingham, Mass., USA (2000), all of which are incorporated by reference herein in their entirety.

The ML optical disk has the same geometry and pit spacing as a conventional CD, but achieves approximately three times the storage capacity as a CD by allowing each pit (or “data cell”) to communicate three bits of information by means of variations in the intensity of reflected light (“gray scales”). By being the same size and tolerances as conventional CD's, the pressing costs of ML disks are similar to the low costs of pressing a conventional CD. ML disks are superior storage media to CD's since their 2 gigabyte capacity as compared to 0.65 gigabytes allows storage of a full-length movie with VHS quality via commercially available video compression techniques such as MPEG-2, MPEG-4 or other proprietary compression techniques such as those developed and used by Sorenson Media, without the complexity of multiple disks with attendant user issues and possible pauses as disks are changed.

Readers for ML disks are mechanically identical to CD readers since ML disks and CD's share the same track and pit geometry, and can be read with the same lasers and photodetectors. Thus ML readers such as reader box 14 of FIGS. 1 and 2 can be brought to market quickly for low cost by well developed CD reader manufacturing companies.

Writers for ML disks may be mechanically identical to CD writers since ML disks and CD's share the same pit and track geometry and can be written with the same laser diodes. Unlike CD writers, however, pits of different reflectance must be written on ML disks to create the necessary gray scale. This is accomplished by controlling the duration and/or number of light pulses from the laser during the write process in conjunction with utilizing a writable surface that is responsive to these pulses in such a manner as to create the gray scale of reflectances at the pits, all of which may be accomplished in accordance with the technologies of the mentioned ML Alliance.

Readers and writers for ML players require signal processing electronics that is both more advanced and proprietary than the electronics used in association with conventional CD's, allowing the ML disk system to be more secure than conventional music and video recording systems. At the first level of security, ML disk gray-scales are unreadable by conventional CD or computer readers, since these devices output just one bit per pit, and signal processing is required to interpolate the gray scales of pit reflectance into three-bit digital data. The signal processing is accomplished in an ML reader by an ASIC (application specific integrated circuit) employing proprietary methods of calibrating the signal as well as the use of proprietary codes to minimize bit errors due to occasional errors in differentiating between adjacent grays such as described in U.S. Pat. No. 6,148,428, “Method and apparatus for Modulation Encoding Data for Storage on a Multi-Level Optical Recording Medium”. The proprietary ASIC converts the analog photodetector output to a 3-bit or more digital signal based upon calibration data that is included in each frame of data. The ASIC chipset also implements the error reduction techniques as described in the '428 patent. This chipset also can be designed to block the outputting of data frames that contain specific header information. Thus, ASIC's may be produced for different applications that reliably protect information. For example, the ASIC used in an ML reader/writer for computer use may be designed so that it will refuse to output data from any frame containing the bit combination “V”. ASIC's used with the set-top boxes 14 of the present invention may have an ASIC that only outputs frames with an “V” in the frame header. Thus, to read the video from an ML disk with any reader but a chip specifically designed for such a set-top box would require a complex ASIC that would be both difficult and illegal to produce.

As mentioned above, ML technology provides a 3× improvement over conventional CD storage capacity using existing optics, mechanics and manufacturing infrastructure, while also offering write speeds at 3× current CD write speeds, for example, write speeds of 36× to 60×, and above. Additionally, the ASIC chipset for writing and reading ML-encoded disks provides backwards compatibility with legacy CD's. Thus, in certain preferred embodiments of the present invention, a read/write system employing ML technology may be made even more versatile by providing an additional write capability that permits writing conventional CD's (0.65 gigabytes) so that the read/write system can write CD's readable by any conventional CD player, in addition to writing proprietary ML disks.

As described in detail elsewhere herein, security of the recorded content is of utmost importance to the system operator and the content providers. According to the present invention, the system operator has a unique advantage to implement any number of security measures. Using proprietary ML technology and a unique ASIC chipset designed specifically for the system operator, the security measures available for the recorded content may include:

1. Digital rights management via a standardized software protocol such as offered by InterTrust Technology Corporation of Santa Clara, Calif., USA;

2. Watermarking;

3. Custom tailored compression technologies;

4. Encryption;

5. ML proprietary technology;

6. Unique ASIC chipset for implementing the ML technology for the system operator.

It will be appreciated that the enhanced storage capacity and write speeds associated with ML technology increase the attractiveness of producing standard or custom video CD's for system customers. CD's so produced at customer request are added to the customer's video archives. As mentioned above, a full-length movie may be stored on a single ML CD. (Or, approximately 30 compressed record albums may be stored on a single ML CD.) Furthermore, as described in the ML technology literature identified above, ML technology may be extended in the future to DVD media to increase DVD storage capacity and write speeds by 3× or more. ML DVD technology may be used in accordance with the invention when available.

Two examples of distribution agent operations follow:

### EXAMPLE I

An individual such as a high school or college student owns an in home duplication system that he purchased as part of a general ML CD duplicator box (dual well). Optionally, the additional cost of incorporating the ML chips into the box may be underwritten by the video distribution system operator. The box plays ML video disks as well as copies them. The box may be supplied to the distribution agent with ten to twenty movies and a large number of blank movie disks. When a movie is watched on the box, the box is invoiced by a communication system in the same manner as a movie watched on a play-only box as shown in FIGS. 1 and 2. The connection establishes the billing and conveys the identification of the distribution agent who is the source of the disk.

The student may burn multiple copies of a new movie he enjoyed and give it to friends who have proprietary ML boxes such as box 14 of FIGS. 1 and 2. Some portion of the revenues from each movie viewing is returned to the student. The return is in the form of movie viewing credits, free media selections of more movies to be shipped to the student, or other suitable reward. The student may also be “paid” by free music CD's or other gifts as once existed in cigarette clubs or credits that could be used for internet use or purchases.

### EXAMPLE II

A Quickie Mart convenience store rents, sells and/or gives away proprietary ML movie disks and, perhaps, player boxes that return revenues to the Mart as movies are played on them. Disks that are sold may be sold for, say, 50 cents each with $.25 credit for disks returned without scratches. The Mart maintains a stock of several hundred disks with a small computer system that predicts sales of “hot” disks and urges the owner to copy more. The copy device may be used on a “while you wait” basis by customers, looking much like a juke box and running on quarters or returned CD's. Similarly, the store owner may have a larger ten-disk ML burner in the back of the store. The burner may have been originally purchased, but is rapidly paid for by credits to the store owner as disks copied by the burner are played by customers and their boxes send the store's ID code into the system operator's central billing system. Additionally, the Quickie Mart may also rent portable players for vacation trips or just for a week's use. The rental box may come with a set number of prepaid viewings, for example, ten viewings, with the customer being refunded for unused viewings when the box is returned. In the alternative, the Mart owner may simply loan a dozen movie disks to the rental box customer. Many variations of rent, trade, and recycle strategies are possible, underwritten by the per-view revenues back to the store and possible subsidy of hardware from the distribution system operator. Consumers are frequently lured by such a maze of incentives, much like the lure of lotto tickets or cell phone rentals.

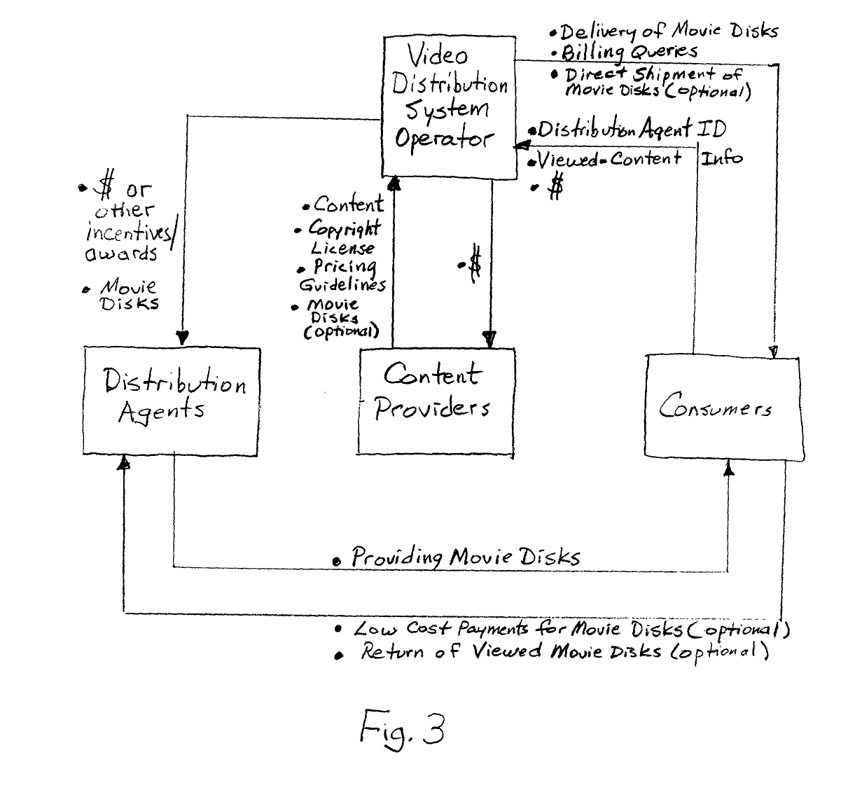

The present invention provides flexibility with respect to the business model to be used to commercialize the invention. In one simplified embodiment, shown in block diagram form in FIG. 3, the video distribution system operator interfaces with three parties: content providers, distribution agents and consumers. The content providers provide the content (e.g., movies) to the video distribution system operator along with the necessary copyright license and pricing guidelines. The content may be delivered in any suitable digital form, including delivery of fully encoded proprietary optical disks. The system operator is responsible for producing or having produced large numbers of movie disks for distribution to the various classes of distribution agents, as well as having the option of directly shipping movie disks to consumers via direct customer orders, a “record club” model, or the like. The distribution agents are responsible for providing movie disks to customers in the various ways described above. While many of the distribution agents preferably have the capability for on-site duplication of music disks, some or all of the distribution by some agents may be a pass through of pressed disks received directly from the system operator. When consumers view movies, viewed-content information and distribution agent identification information are sent to the system operator by communication means as described above, with or without billing queries initiated by the system operator. Consumer payment is made to the system operator by credit card, direct billing, as additional purchases on a cable or direct broadcast satellite account, or other suitable payment means. The system operator, in turn, pays royalties to the content providers and provides compensation to the distribution agents in the form of cash or incentives/rewards. It will be appreciated that in certain embodiments, the invention may be carried out in substantial part without duplication of movie disks by distribution agents, with many of the disks being pressed by the system operator and/or content providers or parties under their control.

In those instances where multiple copies are made by different agents before a particular disk reaches a consumer, the agent payments to the responsible distribution agents may be divided equally among all agents in the copy chain, or, more preferably, payments may be made in a sort of pyramid arrangement with the distribution agents closer to the consumer receiving greater credits than those further upstream.

It will be appreciated that the invention may be carried out in conjunction with other distribution strategies for delivering content to the customer households. In this regard, the invention may be carried out in conjunction with a digital movie distribution system whereby movies are blanket broadcast by direct broadcast satellite, cable or other means to set-top boxes that record movies according to the customer's dictates or preferences, thus giving the customer the option of receiving content in the form of physical delivery of movie disks or by digital download to his set-top box. Digital movie distribution systems that may be used in conjunction with this invention are described in commonly assigned U.S. patent application Ser. No. 09/385,671, filed Aug. 27, 1999; Ser. No. 09/436,281, filed Nov. 8, 1999; Ser. No. 09/476,078, filed Dec. 30, 1999; Ser. No. 09/502,069, filed Feb. 10, 2000; Ser. No. 09/553,524, filed Apr. 20, 2000; Ser. No. 09/645,087, filed Aug. 24, 2000; Ser. No. 09/675,025, filed Sep. 28, 2000; and Ser. No. 09/737,826, filed Dec. 15, 2000. These applications describe various features of video distribution systems that have application to this invention, including various security measures for protecting content. The contents of these applications are incorporated by reference herein in their entirety.

As movie distribution according to this invention moves into the homes of millions of viewers, providing an updated guide and index of what is available in the viewers' home libraries becomes an ever increasing need. To this end, according to the invention, a CD-based in-home entertainment guide may be provided to system customers. The CD-based guide can be updated from the internet, wireless, phone connection, other data transmission, or by physical replacement, enabling the customer to place the guide CD into the player unit and scroll through all the movies available to him, including movie information like pricing, ratings, previews, reviews, rankings, actor and actress information, behind the movie footage, etc. With the guide CD installed, the player will compare the digital rights purchase by the customer, and give the customer a choice of listing all movies available, just the ones he currently has rights for, or any number of other categories, like rating, theme, actor or actress, date, author, etc. The customer puts the guide CD into the unit and a graphical menu of his desired information is displayed on the connected TV, video screen, or other monitor source. From this menu, the customer finds out what movies are available and will be given the specific CD number or index where the movie or other entertainment can be found. With this information the customer can easily find the right CD he is interested in. While online TV guides exist, many customers will not have access to digital cable, the internet, or direct broadcast satellite service. In addition, since the present invention does not depend upon broadcast TV, the in-home entertainment guide represents a significant component of a system designed to achieve overall customer satisfaction and convenience of use.

Additionally, the in-home entertainment guide can be updated with current advertisements that are highlighted based on the customer's current view of the entertainment content. The guide may also become a local ordering vehicle for the customer to easily request new entertainment or entertainment packages via the playback device back-channel over wireless, phone, internet or other communication medium.

While the present invention has been described in connection with certain illustrated embodiments and terminology, it will be appreciated that modifications may be made without departing from the true spirit and scope of the invention. In this regard, the term “movies” as used herein is deemed to encompass not only full-length feature films, but also content such as classic sporting events (e.g., Super Bowls), popular TV series (e.g., episodes of Star Trek or Seinfeld or I Love Lucy), or any other video content suitable for distribution. Similarly, it will be appreciated that the terms “digital movie media”, “digital movie disks”, “movie disks” and the like as used herein are not limited to CD, DVD, CD-like and DVD-like optical disks, but may encompass other optical media as well as magnetic and other media suitable to store movies in digital form. While proprietary CD-like media such as the above-described “ML” media may be preferred for the reasons stated herein, other media such as the optical storage media of Dataplay Company, USA may be utilized. Also, standard CD's recorded on one or both sides, preferably with sufficient data compression to enable a movie to be stored on a single CD, may be used.

That which is claimed:

1. A method of distributing movies to customer households comprising the steps of:
under authority of content providers who control the distribution rights to movies, delivering digital movie disks to widely geographically dispersed distribution agents;
having distribution agents produce copies of the movie disks, each copy including an identification code that identifies the distribution agent who made the copy;
distributing the movie disk copies from the distribution agents to customer households that have playback devices compatible with the disks;
permitting the customer households to view desired movies through their playback devices;
communicating from the customer households movie playback information that identifies each movie that has been viewed and a distribution agent who is responsible for the movie being distributed to the customer household; and
as dictated by the movie playback information, compensating content providers and responsible distribution agents.
